(19) United States
(12) Patent Application Publication
(10) Pub. No.: US 2007/0128472 A1
(43) Pub. Date: Jun. 7, 2007

(54) Cell Assembly and Casing Assembly for a Power Storage Device

(76) Inventors: T. Kirkwood Tierney, Schomberg (CA); Robert G. Averill, Ringwood, NJ (US); Adam J. Swiecki, Milton (CA)

Correspondence Address: CAHN & SAMUELS LLP, 2000 P STREET NW, SUITE 200, WASHINGTON, DC, 20036, US

(21) Appl. No.: 11/550,708

(22) Filed: Oct. 18, 2006

Related U.S. Application Data
(60) Provisional application No. 60/730,397, filed on Oct. 27, 2005.

(51) Int. Cl. H01M 12/00; H01M 10/20; H01M 10/22; H01G 9/04

(52) U.S. Cl. 429/9; 429/225; 429/204; 361/503

(57) ABSTRACT

A hybrid lead acid battery and porous carbon supercapacitor energy storage device is asymmetrically supercapacitive and comprises at least one lead electrode, at least two carbon-based electrodes, a separator, a casing, and an acid electrolyte. The lead electrode has a non-conductive sheet of porous material which envelops a lead based mass and lead-based current collector. Each carbon-based electrode is moderately conductive, having a sheet of highly conductive material between two sheets of electrically conductive shield material, and highly porous carbon adhered to the highly conductive material. The casing applies and maintains compression forces against the faces of the electrodes, and provides a void space in the interior of an assembled energy storage device.

### I. CROSS REFERENCE TO RELATED APPLICATIONS

This application is an application filed under 35 U.S.C. § 111(a) claiming benefit pursuant to 35 U.S.C. § 119(e)(1) of the filing date of the Provisional Application 60/730,397 filed on Oct. 27, 2005 pursuant to 35 U.S.C. § 111(b), the entire contents of which are incorporated herein by reference.

### II. FIELD OF THE INVENTION

The present invention relates generally to an electric energy storage device, and more specifically it relates to a cell assembly and casing assembly for a flexible and economical multi-plate hybrid battery supercapacitor.

### III. BACKGROUND OF THE INVENTION

Typically, the most common electrical energy storage devices are electrochemical batteries and capacitors, including supercapacitors. This device is an implementation of a hybrid lead acid battery and porous carbon supercapacitor, which has features and performance which are distinct from either an electrochemical battery or a supercapacitor.

A significant amount of the energy in this type of hybrid is stored electrostatically, and a significant amount of energy is stored electrochemically as well. The disclosed device has a significantly greater cycle life than a lead-acid battery a deeper discharge capability and a much more rapid charge time. The disclosed device also has a much greater energy density than a supercapacitor. Unlike a supercapacitor, it exhibits a linear decline in voltage as it is used, as well as a linear increase in voltage when it is charged. While this type of device typically requires power conversion interface for many applications, it also delivers an accurate instantaneous mapping of its state of charge. Because half of the cell design disclosed herein is similar to conventional lead-acid battery constructs, many common components can be used, as well as many common strategies, methods and designs for tuning and enhancing performance.

One main problem with the use of conventional lead-acid battery components within this type of device is that the current collection methods needed for carbon electrodes are significantly different than those of lead based electrodes. For instance, because of the lesser conductivity of carbon electrodes, the need for maximum surface contact and a short electrical path between the carbon electrode and the underlying collector assembly is paramount. Another problem is corrosion due to electrochemical interaction between the current collector and an electrolyte. A further problem is the negative effects of electrochemical interaction between the current collector and the carbon electrode. A further problem is the need for greater than normal internal compression in order to enhance the points of mechanical contact between porous carbon particles, and thus to increase internal conductivity. Yet another issue is caused by the variance in the internal compression due to settling of materials or other changes over time.

In these respects, the disclosed cell assembly and casing assembly for a power storage device, according to the present invention, substantially depart from the conventional concepts and designs of the prior art, and in so doing, provide an apparatus which is a flexible and economical method of creating a multi-plate, multi-cell, hybrid lead acid battery/supercapacitor energy storage device.

### IV. SUMMARY OF THE INVENTION

The general purpose of the present invention, which will be described subsequently in greater detail, is to provide a new cell assembly and casing assembly for an energy storage device that has the advantages mentioned heretofore and many novel construction features that are not anticipated, rendered obvious, suggested, or even implied by any of the prior art energy storage device, either alone or in any combination thereof.

The present invention achieves the above-stated general purpose by combining a highly conductive carbon compatible current collector assembly, highly porous carbon based electrodes applied to the carbon compatible current collector assembly, a lead based current collector, an active lead based mass (applied to the lead based collector) substantially consisting of lead, lead dioxide, or lead sulfate, a separator, a quantity of electrolyte, and a case assembly.

A suitable carbon compatible current collector assembly for the invention is formed from a sheet of highly electrically conductive material sandwiched between two sheets of electrically conductive, chemically resistant shield material. A conductive attachment feature for the current conductor is used for electrical interconnection to other components. An area of the conductive shield is used to seal two shields together.

An electrically conductive, chemically resistant shield may be used in the invention, preferably comprising an electrochemically resistant material, selected so as to be electrically conductive and non-chemically reactive within the device, so as to resist electrolyte penetration or interaction, but to allow the passage of electrical current through to the underlying more highly electrically conductive material that it encloses and protects.

The invention further contemplates forming highly porous carbon for engaging the current collector assembly, which is preferably processed so as to contact the current collector assembly, forming a carbon electrode assembly.

An alternate variant of the carbon electrode assembly is comprised of a current collector assembly sandwiched between two sheets of porous carbon, and may be used as a component in multi-plate hybrid cells.

A lead mass and grid assembly preferably is comprised of lead based active mass paste covering an interior grid of lead or lead alloy. An area of the grid is used as a tab feature for electrical interconnection to other components.

A lead electrode assembly is comprised of a low-conductivity active porous material which envelopes the lead mass and grid assembly, whereby the material insulates the components while allowing the passage of electrolyte and lead based ions.

A hybrid cell assembly is comprised of at least one carbon electrode assembly, at least one lead electrode assembly, and a quantity of a sulfuric acid based electrolyte.

More preferentially, an alternate hybrid cell assembly is comprised of two or more carbon electrode assemblies, one or more lead electrode assemblies, and two or more carbon electrode interior assemblies. This assembly ensures that the lead electrode assembly is surrounded on both sides by carbon electrode assemblies.

An enclosure assembly is described, comprising a metallic lug used to electrically interconnect the lead electrode tabs, a metallic lug used to electrically interconnect the carbon electrode tabs, a top assembly which connects to the cell casing and through which protrude the positive and negative lugs, and an enclosure capable of containing a hybrid cell with electrolyte.

Finally, the cell casing assembly is enclosed in a mechanical assembly consisting of a first end plate assembly with connective tensioning rods, a second end plate which mates with the first end plate assembly, and which, via thread and nut features, transmits compression through the casing into the entire internal cell component stack.

There has thus been outlined, rather broadly, features of the invention, in order that the detailed description thereof maybe better understood, and in order that the present contribution to the art may be better appreciated. There are additional features of the invention that will be described hereinafter.

In particular, the present invention provides a hybrid lead acid battery and porous carbon supercapacitor energy storage device, comprising at least one lead electrode, at least one carbon-based electrode, a separator, a casing, and an acid electrolyte.

The at least one lead electrode comprises an active lead-based mass applied to a lead-based current collector, and a low-conductivity sheet of porous material which envelops the lead based mass and the lead-based current collector so as to insulate the same and so as to permit passage of electrolyte and lead-based ions therethrough.

Each of the carbon-based electrodes is moderately conductive, and comprises a sheet of highly conductive material sealed between two sheets of electrically conductive shield material which is chemically resistant to said acid electrolyte, and highly porous carbon in electrical contact with the sheet of highly conductive material.

The casing is such as to apply and maintain compression forces against the faces of the at least one lead electrode and the at least two carbon-based electrodes, when assembled, and to provide a void space in the interior of an assembled energy storage device.

Energy is stored in the at least two carbon-based electrodes both electrostatically and electrochemically, and in the at least one lead electrode electrochemically.

The active lead-based mass is chosen from the group consisting of lead, lead dioxide, and lead sulfate, and mixtures and combinations thereof. The acid electrolyte is sulfuric acid.

The sheet of highly conductive material is comprised of a sheet of highly conductive metal chosen from the group consisting of copper and copper alloys, or a conductive composite chosen from the group consisting of thermoplastic materials filled with conductive fillers, thermal-set plastic materials filled with conductive fillers, and combinations thereof.

The conductive fillers are chosen from the group consisting of conductive metallic fibers, conductive non-metallic fibers, highly conductive carbon particles, highly conductive carbon fibers, and mixtures and combinations thereof.

The conductive shield material comprises a sheet of expanded graphite foil impregnated with a material chosen from the group consisting of paraffin, other waxes, thermoplastic materials, PTFE, furfural, and mixtures and combinations thereof.

The conductive shield material comprises expanded graphite flakes containing materials chosen from the group consisting of carbon, graphite powder, highly conductive carbon fibers having a high aspect ratio, paraffin, other waxes, thermoplastic materials, and mixtures and combinations thereof.

The sheets of electrically conductive shield material are sealed around the periphery of the highly conductive material and the highly porous carbon is in electrical contact therewith, whereby each carbon-based electrode is an encapsulated electrode.

Each of the electrodes has a tab affixed thereto so as to be electrically connected to a respective positive or negative external lug wherein the energy storage device is assembled.

The seal around the periphery of the highly conductive material and the highly porous carbon contacted thereto, is effected by a method chosen from the group consisting of applying heat to the seal area, applying pressure to the seal area, applying heat and pressure to the seal area, applying adhesive glue to the seal area, applying additional paraffin to the seal area, applying a sealing gasket material comprised of thermoplastic film to the seal area, and combinations thereof.

The highly porous carbon contains inert binder material added to highly porous carbon particles, and the inert binder material is chosen from the group consisting of polyethylene powder, thermoplastic powder, thermoplastic granules, and mixtures and combinations thereof.

The casing is hermetically sealed, and applies and maintains compression forces against faces of the at least one lead electrode and the at least one carbon-based electrode by having at least a pair of opposed pressure plates secured one to the other by tension rods or other tensioning means passed therethrough.

At least one of the carbon-based electrodes may comprise a sheet of highly conductive material which is sandwiched between two sheets of porous carbon material.

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

Consistent with the foregoing, a primary object of the present invention is to provide a cell assembly and casing assembly for an energy storage device that will overcome several shortcomings of the prior art energy storage devices.

Another object of the present invention is to provide a cell assembly and casing assembly for an energy storage device to provide an apparatus which provides a flexible and economical method of creating a multi-plate hybrid battery/supercapacitor energy storage device.

A further object of the present invention is to provide a cell assembly and casing assembly for an energy storage device that provides chemically compatible highly conductive interface to the porous carbon electrode.

Still another object of the present invention is to provide a cell assembly and casing assembly for an energy storage device that is highly inert with respect to the chemical interactions with the electrolyte.

Yet another object is to provide a cell assembly and casing assembly for an energy storage device that is easily assembled into multi-plate cells.

An additional object is to provide a cell assembly and casing assembly for an energy storage device that is manufacturable by conventional processes and with economical materials.

A further object of this present invention is to be readily combinable with existing technologies and particularly, with lead dioxide hybrid devices such as those described in commonly owned U.S. Pat. Nos. 6,466,429 and 6,628,504, hybrid devices incorporating activated carbon electrodes such as those described in commonly owned U.S. Pat. No. 6,706,079, high performance positive electrodes for use with hybrid electrochemical capacitors as described in commonly owned, U.S. Pat. No. 7,006,346 and carbon electrodes bound with polyethylene as described in commonly owned U.S. Pat. No. 7,110,242, the content of all of which are incorporated herein by reference.

Other objects and advantages of the present invention should become evident to a reader having ordinary skill in this art and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated. Various other objects, features and attendant Oadvantages of the present invention will become fully appreciated and better understood when considered in conjunction with the accompanying drawings, in which like reference characters designate the same or similar parts throughout the several views. Given the following enabling description of the drawings, the apparatus should become evident to a person of ordinary skill in the art.

### V. BRIEF DESRIPTION OF THE DRAWINGS

FIG. 1 is an exploded view showing current collector subassembly elements.

FIG. 2 is an exploded view showing carbon electrode subassembly elements.

FIG. 3 is a side view of the two forms of the carbon electrode subassembly.

FIG. 4 is an exploded view showing lead electrode subassembly elements.

FIG. 5 is a side view of a single lead plate form of the hybrid cell.

FIG. 6 is a side view of a multiple lead plate form of the hybrid cell.

FIG. 7 is an exploded view showing casing subassembly elements.

FIG. 8 is a perspective view showing an assembled hybrid battery/supercapacitor device.

FIG. 9 is a section view in the direction of arrows 9-9 in FIG. 8.

### VI. DETAILED DESCRIPTION OF THE DRAWINGS

For the purpose of this application, Applicants adopt the following definitions for interpretation of the written description.

As used herein “connect”, “connection”, “interconnected” and the like, include a link, whether direct or indirect, electrical or physical depending on the context, permanently positioned, removably fastened, or adjustably mounted. Thus, unless specified, “connected”, “interconnected” and the like is intended to embrace an operationally functional connection/interconnection.

As used herein “substantially,” “generally,” and other words of degree are relative modifiers intended to indicate permissible variation from the characteristic so modified. It is not intended to be limited to the absolute value or characteristic which it modifies but rather possessing more of the physical or functional characteristic than its opposite, and preferably, approaching or approximating such a physical or functional characteristic.

Turning now descriptively to the drawings, in which similar reference characters denote similar elements throughout the several views, the attached figures illustrate a cell assembly and casing assembly for an energy storage device.

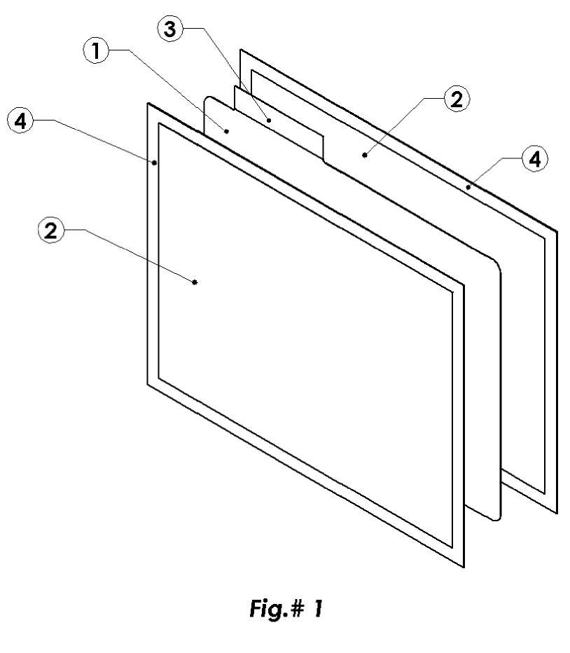

Referring now to FIG. 1, a current conductor (1) is manufactured from a thin sheet of material, commonly by a die cut process. The material is most commonly a highly conductive metal. In this embodiment, the conductor shown is a thin, flat sheet of copper. Variants for the conductor include other common metal materials and alloys; also, various shapes, including shapes with interior holes; also various thicknesses; also the use of conductive overcoats on the material to enhance bonding; also the use of conductive composites in place of metals. The composites could, for example, include either thermoplastics or thermo-set plastics together with conductive fillers, wherein the fillers may be metallic or non metallic, including highly conductive carbon materials.

Referring still to FIG. 1, a conductive shield (2) is an electrochemically resistant material, selected so as to be highly electrically conductive and yet not significantly reactive with the acid electrolyte used in this cell construct, nor with such chemical byproducts as may exist in various stages of the electrochemical reactions used in this cell construct. In this embodiment, the conductive shield is comprised of a sheet or layer of graphite foil, impregnated with paraffin via vacuum oven processing, and drawn into the interior of interior of the foil. The resulting conductive shield resists electrolyte penetration or interaction, but allows the conduction of electrical current through the interconnected graphite flakes.

Variants of construction of (2) also include the use of other materials in addition to paraffin or in substitution to paraffin, selected from materials able to seal the interior of the graphite while allowing conductivity. These can include waxes, thermoplastics, and similar substances. Variants also include heat and pressure processed graphite paste comprised of carbon or graphite powder and paraffin or another such material. Additives to the composite can include high aspect ratio highly conductive carbon fibers to enhance the conductivity through the sheets or layers.

Referring still to FIG. 1, the tab feature (3) is a construct which attaches to the current conductor (1), and which is used for electrical interconnection to other components. In the preferred embodiment, this is a lead tab, soldered to the copper conductor. Variants include other common solders, crimped leads, and the use of non lead variants thereof. The details of a tab feature are not critical to the overall nature of this invention.

An area of the conductive shield is used to seal two shields together, encapsulating the current conductor. Referring still to FIG. 1, the seal area of the conductive shield (4) is one or more areas where one conductive shield (2) is placed in contact with another conductive shield so as to encapsulate the current conductor (2). The depicted embodiment shows a seal area which encircles the interior of the conductive shield, and which extends beyond the peripheral dimensions of the encapsulated current conductor.

The seal can be established under heat and pressure treatment, or with adhesive glues, or with small additional amounts of paraffin as an adhesive, or with sealing gasket material comprised of thermoplastic film in the seal area. In the embodiment shown, the seal is effected by an adhesive material placed between the two shields and limited to the seal area of the shields. If the current conductor is designed as a grid, then it follows that there can be interior areas that are also part of the seal area. This enhancement uses less current conductor material, decreased the overall weight, and increases the strength of the encapsulation.

Referring still to FIG. 1, an entire subassembly, called a current collector, is constructed by enclosing the current conductor (1) within two layers of the conductive shield (2), and sealing the entire via the seal area (4) so that only a tab feature (3) attached to the current conductor extends beyond the joined shields.

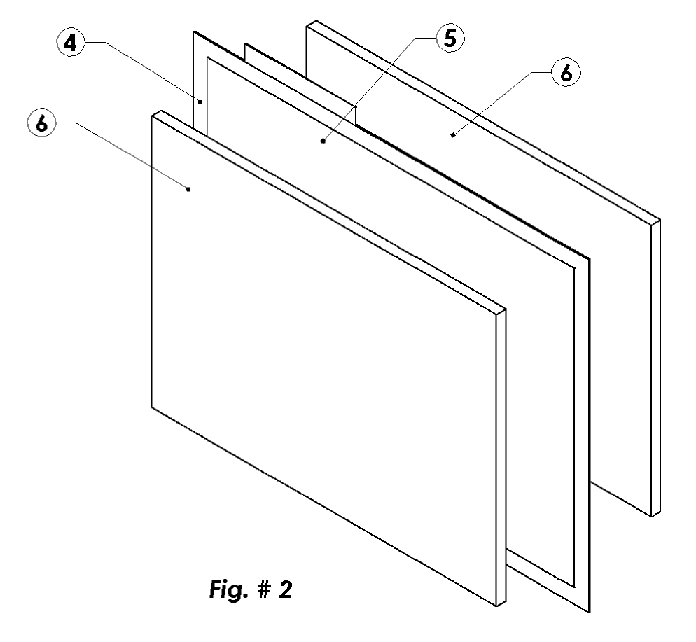

Referring now to FIG. 2, (5) depicts the aforesaid current collector subassembly. Highly porous carbon is formed so that it can contact the current collector. Referring still to FIG. 2, and FIG. 1, a porous carbon material (6) is formed into a sheet or layer which is sized to conform to the dimensions of the current conductor (1) within conductive shields (2). The thickness of the carbon material is determined by the electrochemical or electrostatic requirements of the cell. Thicker carbon materials store more energy, but make a bulkier cell. Thinner materials allow more plates within the same casing size, increasing the power density.

Almost any highly porous carbon material will work to at least some degree. The carbon material in this embodiment is formed as a composite from highly porous carbon particles, with inert binder material added to aid mechanical stability and handling. A successful composite will have the highest surface area that can also allow the flow of evolved gases and liquid electrolyte material within the interior of the carbon structure.

Other additives may also be present in order to aid conductivity, to retard chemical degradation, or to enhance mechanical properties. The exact nature and processing of the carbon material greatly affects the performance of the device, and is the subject of a separate disclosure. The exact nature of the carbon material is not the subject of this patent.

In this embodiment, the binder material is polyethylene powder, adhered to the carbon via a heat and pressure process. Porous carbon can be made from electrically conductive carbon cloth, fibers or granules. Binders can include, for example, thermoplastic powder or granules, or other such materials selected so as to adhere the carbon into a shaped mass without filing in the pore structure of the carbon or interacting chemically with the electrochemical processes of the cell.

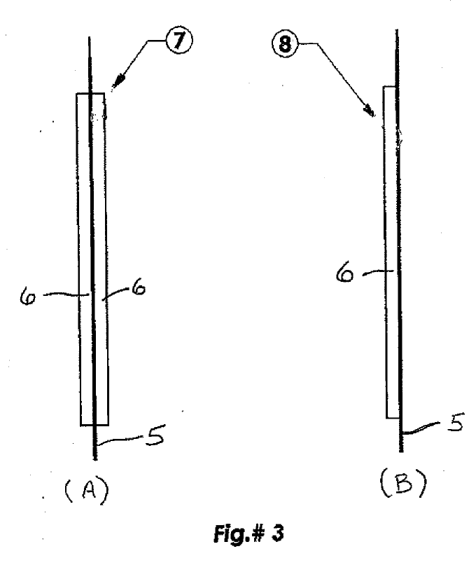

An assembly comprised of porous carbon and a current collector is depicted. Referring now to FIG. 2 and FIG. 3, there is depicted (7) a carbon electrode type A subassembly, comprised of two sheets of porous carbon (6) compressed against a current collector (5) via heat and pressure processing. The attachment can be made by heat and pressure processes, or with adhesives, or with additional amounts of paraffin as an adhesive. In this embodiment, heat and pressure processes are used.

An alternate assembly comprised of porous carbon and a current collector used in the interior of multi-plate cells is also depicted. Referring now to FIG. 2 and FIG. 3, there is depicted (8) a carbon electrode type B subassembly, comprised of a sheet of porous carbon (6) compressed against one side of a current collector (5) via similar processing to (7). Depending upon which side of the current collector assembly (4) to which the porous carbon assembly (5) is attached, there are two obvious variants of this combined component (8) that are used within the cell construction.

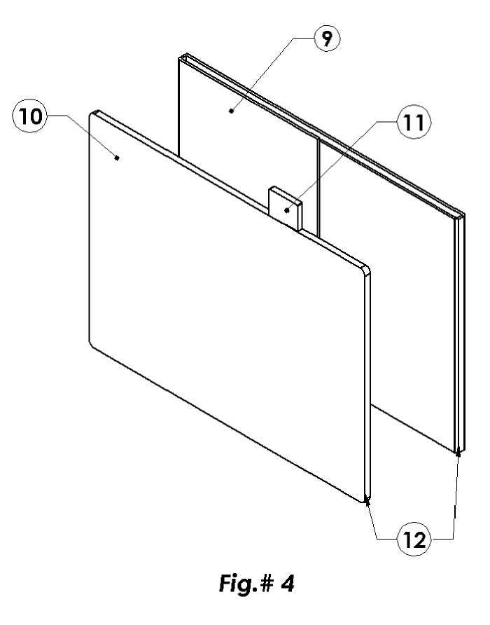

Referring now to FIG. 4, a porous electrically isolative separator (9) is depicted as a sleeve-like structure that can fully surround the lead mass and grid described hereinafter. This separator allows the passage of electrolyte and the exchange of dissolved interchange ions. The construction of these separators is well known to those skilled in the art of lead-acid electrochemical cell design. In this embodiment, the separator is comprised of a glass fiber mat material, commonly known.

An assembly comprised of lead based active mass paste covering an interior grid of lead or lead alloy is depicted. Referring still to FIG. 4, a lead mass and grid assembly (10) is comprised of a lead alloy grid covered in a paste which is further comprised primarily of a mixture of one or more of the following materials: lead oxide, lead dioxide or lead sulfate, or lead. These “active mass” formulations are well known to those skilled in the art of lead-acid electrochemical cell design. There are many well known alternative grid layouts and active mass paste compositions which work effectively.

Referring still to FIG. 4, a tab feature (11) is attached to (10) for the purpose of providing an interconnection to other electrical attachment points within the cell as depicted herein. This feature is most commonly an extension of the lead alloy grid beyond the area which is covered with the active mass paste. There are many well known alternative tab features which work effectively.

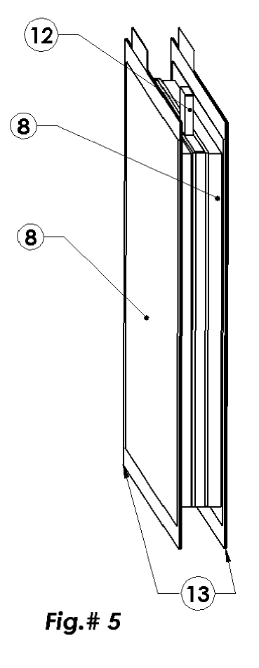

An assembly comprised of a lead mass and grid, a porous separator, and a tab feature is depicted. Referring now to FIG. 4 and FIG. 5, the lead electrode (12) subassembly is comprised of the assembled elements shown in FIG. 5. The tab feature is connected to (or formed upon) the lead alloy grid of the lead mass and grid component (10), and the porous separator (9) is sleeved around the area of the lead mass and grid component (10) where the active mass paste is present, with the tab feature (11) protruding. It is obviously possible to apply dual sheets of porous separator (9) material on either side of (10), or to form a coating of porous separator material upon (10).

An assembly comprised of two carbon electrode type A assemblies, and a lead electrode assembly is depicted. Referring now to FIG. 5, there is depicted a basic single plate hybrid cell subassembly (13), comprised of two carbon electrode type B subassemblies (8) arrayed on either side of a lead electrode subassembly (12). This subassembly, if soaked in a limited amount of electrolyte such that there exists areas of the carbon pore structure which are not fully laden with electrolyte, comprises the most basic variant of the hybrid cell. In this embodiment, the electrolyte is comprised primarily of an aqueous sulfuric acid solution of a type which is commonly known to those skilled in the art of lead-acid electrochemical cell design.

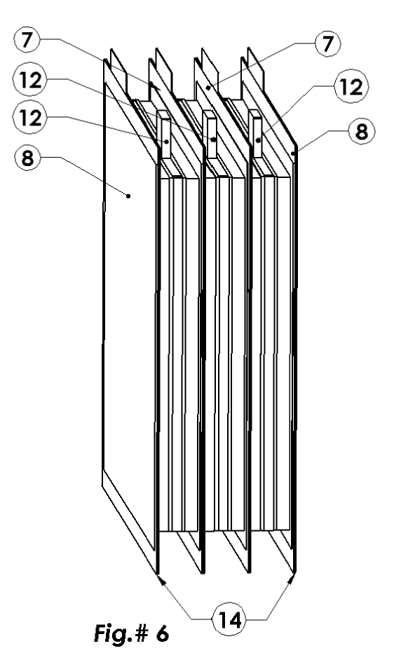

An alternate assembly comprised of two carbon electrode type A assemblies, two or more lead electrode assemblies, one or more carbon electrode type B assemblies is depicted. Referring now to FIG. 6, there is depicted a multi-plate hybrid cell subassembly (14), comprised of two carbon electrode type B subassemblies (8), one or more carbon electrode type A subassemblies (7), and two or more lead electrode subassemblies (12), all arrayed so as to sandwich the (12) components between appropriate type A (7) or type B (8) carbon electrodes. This resulting subassembly comprises a more useful variant of the hybrid cell.

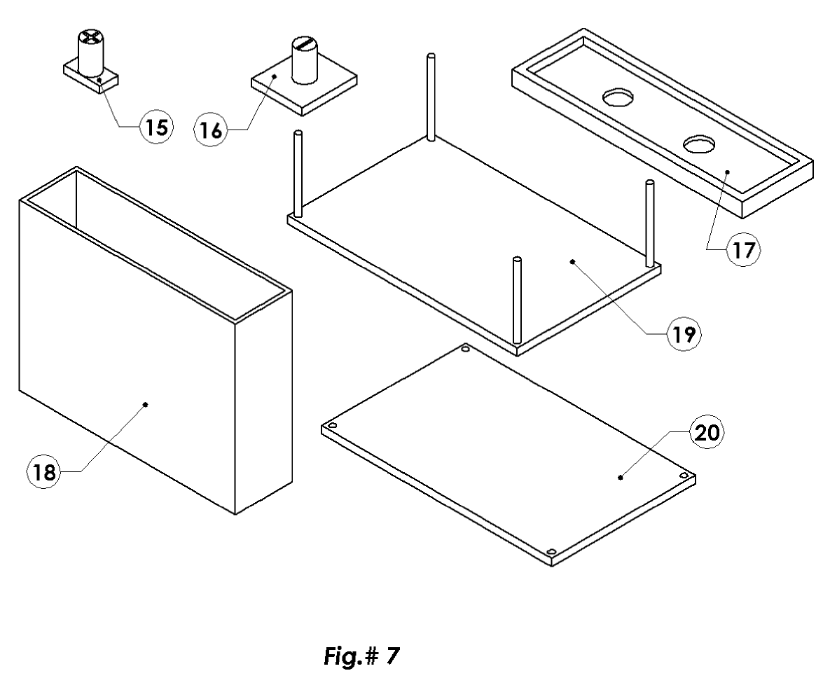

Referring now to FIG. 7, a positive external lug (15) is depicted, designed so that it is able to attach electrically to all the tab features (11) of the lead electrodes (12) enclosed within a cell. The depicted lug is comprised of formed lead, soldered to the tab features (11). There are many well known alternative lug arrangements which work effectively.

Referring still to FIG. 7, a negative external lug (16) is depicted, designed so that it is able to attach electrically to all the tab features (3) of the carbon electrodes (7) or (8) enclosed within a cell. The depicted lug is comprised of formed lead soldered to the tab features (3). There are many well known alternative lug arrangements which work effectively.

A top case assembly component which connects to the cell casing and through which protrude the positive and negative lugs is depicted. Referring still to FIG. 7, a cell casing top (17) is designed to allow sealed attachment to a cell casing, and sealed protrusion of lugs (15) and (16). The lugs are constructed so that all of the electrical charge in all of the corresponding plates in the cell is available to be drawn from the lugs. In this embodiment, the top is comprised of a thermoplastic such as polypropylene. The casing top may also include features such as valved pressure release features, and other features such as are commonly known to one skilled in the art of lead-acid electrochemical cell design. Many casing materials may alternately be used.

Referring still to FIG. 7, a cell casing (18) is designed to contain a hybrid cell assembly (14 or 15), sealed so as to allow a common sump area which holds any excess electrolyte and any gas. Effectively, when the top is applied and sealed, the cell is hermetically contained and enclosed. In this embodiment, the top is comprised of a thermoplastic such as polypropylene. Many casing materials and design variants such as are commonly known to one skilled in the art of lead-acid electrochemical cell design may alternately be used.

A mechanical assembly consisting of an end plate with connective tensioning rods is depicted. Referring still to FIG. 7, a pressure plate assembly A (19), comprised of a flat plate with threaded tensioning rods is depicted. This is part of a compressive assembly, of which many obvious variants can be contrived. Obvious variants include internal plates, wedge compressioners, springs and spring plates, etc. Referring still to FIG. 7, a pressure plate assembly B (20), comprised of a flat plate with holes positioned so as to accommodate tensioning rods (19) passed therethough.

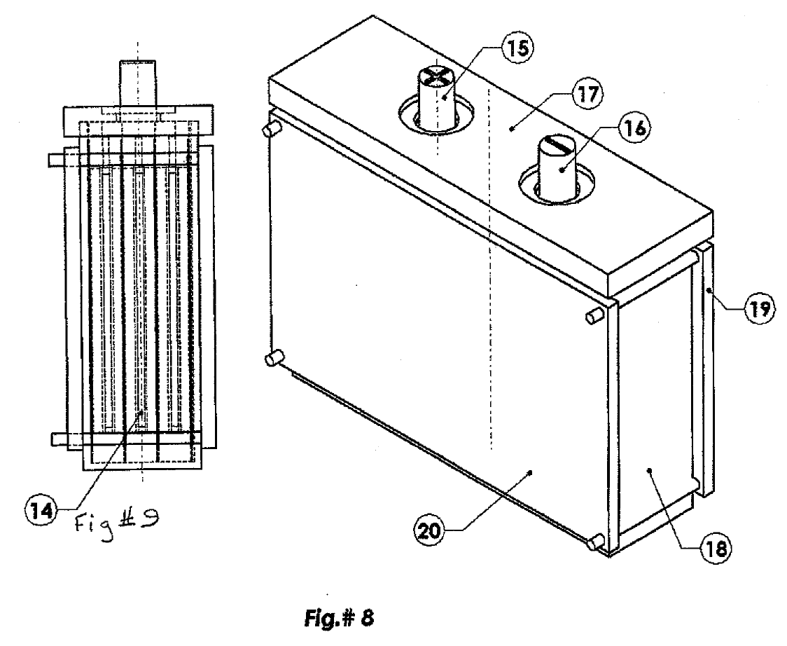

Referring to FIG. 8, a completed assembly shows plate (20) connected to plate assembly (19), to compress casing (18), which flexes to transmit compression into cell components (14) or (13) (not shown, but contained within). In this embodiment, the threaded tension rods of (19) are engaged with nuts (not shown) that can be tightened to a set torque resistance in order to apply the correct compression on the overall assembly. This compression increases the quality of mechanical contact between the paste and the lead grid of (10), between the porous carbon (6) and the current collector (5), and within the material of the porous carbon. This compression contributes to reduced internal resistance and higher cell performance. This is part of a compressive assembly, of which many obvious variants can be contrived, including the use of spring devices to aid the setting and maintenance of compression over time.

Variants and extensions of this assembly include designs for multiple cell housings, with serial or parallel cell interconnection. These are comprised of the depicted cells. An alternate line of variation includes the serial interconnection of elements within a common cell. The interconnection methods require different but obvious tab design variants and different but obvious interconnections.

As to a further discussion of the manner of usage and operation of the present invention, the electrochemical operation of the device is generally known to one skilled in the design of hybrid lead acid battery and porous carbon supercapacitor devices, and should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the skill in the art, and, thus, equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A hybrid lead acid battery and porous carbon supercapacitor energy storage device, comprising at least one lead electrode, at least one carbon-based electrode, a separator, a casing, and an acid electrolyte;
wherein said at least one lead electrode comprises an active lead-based mass applied to a lead-based current collector, and a low conductivity sheet of porous material which envelops said lead based mass and said lead-based current collector so as to insulate the same and so as to permit passage of electrolyte and lead-based ions therethrough;
wherein said at least one carbon-based electrode comprises a sheet of highly conductive material sealed between two sheets of electrically conductive shield material which is chemically resistant to said acid electrolyte, and highly porous carbon in electrical contact with said sheet of highly conductive material; and
wherein said casing is such as to apply and maintain compression forces against the faces of said at least one lead electrode and said at least two carbon-based electrodes, when assembled, and to provide a void space in the interior of an assembled energy storage device.

2. The hybrid lead-carbon-acid energy storage device of claim 1, wherein energy is stored in said at least one carbon-based electrode both electrostatically and electrochemically, and in said at least one lead electrode electrochemically.

3. The hybrid lead-carbon-acid energy storage device of claim 1, wherein said active lead-based mass is selected from the group consisting of lead, lead dioxide, and lead sulfate, and mixtures and combinations thereof; and
wherein said acid electrolyte is sulfuric acid.

4. The hybrid lead-carbon-acid energy storage device of claim 1, wherein said sheet of highly conductive material is comprised of a sheet of highly conductive metal selected from the group consisting of copper and copper alloys, or a conductive composite selected from the group consisting of thermoplastic materials filled with conductive fillers, thermoset plastic materials filled with conductive fillers, and combinations thereof; and
wherein said conductive fillers are selected from the group consisting of conductive metallic fibers, conductive non-metallic fibers, highly conductive carbon particles, highly conductive carbon fibers, and mixtures and combinations thereof.

5. The hybrid lead-carbon-acid energy storage device of claim 1, wherein said conductive shield material comprises a sheet of expanded graphite foil impregnated with a material selected from the group consisting of paraffin, other waxes, thermoplastic materials, furfural, and mixtures and combinations thereof.

6. The hybrid lead-carbon-acid energy storage device of claim 1, wherein said conductive shield material comprises expanded graphite flakes containing materials selected from the group consisting of carbon, graphite powder, highly conductive carbon fibers having a high aspect ratio, paraffin, other waxes, thermoplastic materials, and mixtures and combinations thereof.

7. The hybrid lead-carbon-acid energy storage device of claim 1, wherein said sheets of electrically conductive shield material are sealed around the periphery of said highly conductive material and said highly porous carbon, and said highly porous carbon in electrical contact with said highly conductive material, whereby each said carbon-based electrode is an encapsulated electrode.

8. The hybrid lead-carbon-acid energy storage device of claim 1, wherein each of said electrodes has a tab affixed thereto so as to be electrically connected to a respective positive or negative external lug wherein said energy storage device is assembled.

9. The hybrid lead-carbon-acid energy storage device of claim 7, wherein the seal around the periphery of said highly conductive material and said highly porous carbon in electrical contact therewith, is effected by a method chosen from the group consisting of applying heat to the seal area, applying pressure to the seal area, applying heat and pressure to the seal area, applying adhesive glue to the seal area, applying additional paraffin to the seal area, applying a sealing gasket material comprised of thermoplastic film to the seal area, and combinations thereof.

10. The hybrid lead-carbon-acid energy storage device of claim 1, wherein said highly porous carbon contains inert binder material added to highly porous carbon particles, and wherein said inert binder material is selected from the group consisting of polyethylene powder, thermoplastic powder, thermoplastic granules, and mixtures and combinations thereof.

11. The hybrid lead-carbon-acid energy storage device of claim 1, wherein said casing is hermetically sealed, and applies and maintains compression forces against faces of said at least one lead electrode and said at least two carbon-based electrodes by having at least a pair of opposed pressure plates secured one to the other by tensioning means passed therethrough.

12. The hybrid lead-carbon-acid energy storage device of claim 1, wherein at least one of said carbon-based electrodes comprises a sheet of highly conductive material which is sandwiched between two sheets of porous carbon material.

13. An asymmetrically supercapacitive hybrid lead acid battery and porous carbon supercapacitor energy storage device, comprises:
a lead-based mass;
a lead based current collector;
at least a first lead electrode having a face;
a non-conductive sheet of porous material connected with said first lead electrode, said sheet enveloping said lead based mass and said lead-based current collector;
at least two conductive carbon-based electrodes, each having a face, and each including at least one sheet of conductive material with porous carbon adhered to disposed between two sheets of electrically conductive shield material;
a separator, a casing, and an acid electrolyte.

14. The asymmetrically supercapacitive hybrid lead acid battery and porous carbon supercapacitor energy storage device of claim 13 where said at least two conductive carbon based electrodes is moderately conductive.

15. The asymmetrically supercapacitive hybrid lead acid battery and porous carbon supercapacitor energy storage device of claim 14 where said one sheet of conductive materials is highly conductive.

16. The asymmetrically supercapacitive hybrid lead acid battery and porous carbon supercapacitor energy storage device of claim 13 where said casing applies and maintains compression forces against said faces of the electrodes.

17. The asymmetrically supercapacitive hybrid lead acid battery and porous carbon supercapacitor energy storage device of claim 16, where said casing provides an interior void space.
